(19) United States
(12) Patent Application Publication
(10) Pub. No.: US 2024/0084898 A1
(43) Pub. Date: Mar. 14, 2024

(54) NON-POWERED WATER LEAKAGE BLOCKING DEVICE

(71) Applicant: Geuklae Cho, Suwon-si (KR)

(72) Inventor: Geuklae Cho, Suwon-si (KR)

(21) Appl. No.: 18/360,138

(22) Filed: Jul. 27, 2023

(30) Foreign Application Priority Data
Sep. 14, 2022 (KR) 10-2022-0115509

(51) Int. Cl. F16K 1/36; F16K 15/02; F16K 31/60

(52) U.S. Cl. CPC F16K 1/36; F16K 15/025; F16K 31/60

(57) ABSTRACT

Disclosed herein is a non-powered water leakage blocking device. The non-powered water leakage blocking device includes: an opening/closing member configured to be installed on one side of the pipe and selectively open and close the flow path; an elastic member configured to be interposed between the pipe and the opening/closing member and provide elastic force to the opening/closing member in the direction in which the flow path is blocked; a wire member configured such that one end thereof is connected to the opening/closing member and the other end thereof extends; a support member formed to surround one side of the outer surface of the wire member; and a leakage blocking member configured to fix the other end of the wire member to one side of the support member and be decomposed by leaking fluid and thus release a state in which the wire member is fixed.

### CROSS-REFERENCE TO RELATED APPLICATION

This application claims the benefit of Korean Patent Application No. 10-2022-0115509 filed on Sep. 14, 2022, which is hereby incorporated by reference herein in its entirety.

### BACKGROUND

### 1. Technical Field

The present invention relates to a non-powered water leakage blocking device, and more particularly, to a non-powered water leakage blocking device that can be manufactured in a small size, can prevent water leakage by rapidly blocking a flow path when water leakage occurs, can be freely installed in any installation position, and can be applied to various valve structures.

### 2. Description of the Related Art

Apparatuses that use water in homes, offices, factories, etc., such as water purifiers, dishwashers, washing machines, and industrial machines, are generally connected to branched water pipes and receive and use water. In this case, when leakage occurs in a branched pipe or an apparatus using water, a floor may be flooded or damage may occur to the apparatus.

In some cases, in order to prevent damage caused by such water leakage, a water leakage detection sensor is installed in a position corresponding to a suspected water leakage area in a pipeline, and an administrator finds the location of the leakage and takes measures when the leakage is detected by the water leakage detection sensor.

However, since a considerable amount of time has elapsed until leakage is detected and then measures are taken, damage may increase. Accordingly, there is a need for a device that reduces damage by blocking a pipeline at the same time it detects leakage. An example of such a device is disclosed in FIG. 1.

FIG. 1 is a view showing a conventional water leakage blocking device 100.

As shown in FIG. 1, the conventional water leakage blocking device 100 includes: a solenoid valve 110 installed on one side of a pipe P for supplying water to a water supply target object M; a water leakage detection sensor 120 installed in an area corresponding to a suspected water leakage area in locations corresponding to the water supply target object M; and a control unit 130 configured to receive a detection signal from the water leakage detection sensor 120 and control the solenoid valve 110 to block the flow path of the body P.

In the conventional water leakage blocking device 100, when water leakage occurs in the water supply target object M, the water leakage detection sensor 120 generates a detection signal when detecting the water leakage, and the control unit 130 controls the solenoid valve 110 to block the flow path of the pipe P in response to the generated detection signal, thereby blocking water leakage.

However, the conventional water leakage blocking device 100 requires power to operate the individual components. When a power failure occurs or when it is difficult to supply power to the individual components due to the exhaustion of battery power, there is a problem in that the above-described leakage blocking operation cannot be performed when water leakage occurs.

Accordingly, a non-powered leakage blocking device that does not use power has recently been developed, and such a conventional non-powered leakage blocking device is disclosed in FIGS. 2a and 2b.

FIGS. 2a and 2b are diagrams showing a conventional non-powered leakage blocking device 200.

As shown in FIGS. 2a and 2b, the conventional non-powered water leakage blocking device 200 has one side connected to a water supply target object M and the other side connected to an external water supply line and allows water supplied from the outside to be delivered to the water supply target object M. The conventional non-powered water leakage blocking device 200 includes: a housing 210 disposed in a suspected water leakage area of the water supply target object M; an opening/closing unit 220 installed to be movable up and down on one side of the housing 210, and configured to block a flow path in the housing 210 when it is moved downward; an elastic member 230 interposed between the inner surface of the housing 210 and the opening/closing unit 220, and configured to provide elastic force to the opening/closing unit 220 downward; an operation rod 240 formed to extend downward from one side of the opening/closing unit 220; and a water-soluble member 250 installed under the operation rod 240 to support the operation rod 240 in a state where the opening/closing unit 220 is disposed in a position where it opens the flow path.

In this conventional non-powered water leakage blocking device 200, when water leakage occurs in the water supply target object M or a water supply line through which water is supplied to the water supply target object M and leaked water comes into contact with the water soluble member 250, the water soluble member 250 absorbs the water and is contracted, and the operation rod 240 and the opening/closing unit 220 are moved downward by the elastic member 230, thereby blocking the flow path of water.

However, the above-described conventional non-powered water leakage blocking device 200 has problems in that the water-soluble member 250 is formed in a block shape having a specific height in order to support the operation rod 240, so that the water-soluble member 250 needs to absorb a relatively large amount of water to contract, with the result that time is delayed until the flow path is blocked and the above-described conventional non-powered water leakage blocking device 200 does not work for a small amount of leakage.

Furthermore, the conventional non-powered water leakage blocking device 200 has a structure in which the opening/closing unit 220, the water-soluble member 250, and the operation rod 240 are integrated with one another, so that it has problems in that the installation locations thereof are significantly limited and it is difficult to apply the conventional non-powered water leakage blocking device 200 to valves having various structures.

In addition, the conventional non-powered leakage blocking device 200 has a fairly large volume because the water-soluble member 250 needs to be formed to have a specific strength or more in order to stably support the operation rod 240. Accordingly, in order to apply this, there arises a problem in that the size of a valve is also relatively increased.

### Related Art Literature

Patent Document: Korean Utility Model Registration No. 20-0455931 entitled “Leakage Blocking Device for Water Purifier”

### SUMMARY

The present invention has been conceived to overcome the above-described problems, and an object of the present invention is to provide a non-powered water leakage blocking device that can be installed freely in any installation position, can rapidly block water leakage, and can be applied to various valve structures.

According to an aspect of the present invention, there is provided a non-powered water leakage blocking device, the non-powered water leakage blocking device being installed on one side of a pipe through which fluid moves and blocking the flow path of the pipe when leakage occurs, the non-powered water leakage blocking device including: an opening/closing member configured to be installed on one side of the pipe and selectively open and close the flow path; an elastic member configured to be interposed between the pipe and the opening/closing member and provide elastic force to the opening/closing member in the direction in which the flow path is blocked; a wire member configured such that one end thereof is connected to one side of the opening/closing member and the other end thereof extends; a support member formed to surround one side of the outer surface of the wire member; and a leakage blocking member configured to fix the other end of the wire member to one side of the support member in a state in which the wire member is pulled such that the opening/closing member opens the flow path, and further configured to be decomposed by leaking fluid and thus release a state in which the wire member is fixed.

The support member may include: a tube installed to surround at least a portion of the outer surface of the wire member, and configured such that one side thereof is disposed in the pipe; and a fixation member installed on the other side of the tube, and configured such that the other end of the wire member is fixed to one side thereof by the leakage blocking member.

The wire member may include: an operation wire configured such that one end thereof is connected to one side of the opening/closing member; and an auxiliary fixation member coupled to a remaining end of the operation wire, and configured to be fixed to one side of the support member by the leakage blocking member and be released from a fixed state when the leakage blocking member is broken.

The fixation member may be configured such that both side portions thereof are formed such that one side thereof is installed on the other side of the tube and the other side thereof is spread to have elasticity, and support protrusions are formed on the insides of the both side portions; and the other end of the wire member may be fixed to the fixation member by winding the leakage blocking member around the outer surfaces of the both side portions of the fixation member in a state in which both sides of the fixation member are brought close to each other and the other end of the wire member is supported by the support protrusions.

The opening/closing member may include: a valve unit rotatably installed in the pipe, and configured to selectively open and close the flow path; a handle integrated with the valve unit, and connected to the wire member; and an elastic element interposed between the pipe and the handle, and configured to provide rotational force to the handle.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a view showing a conventional water leakage blocking device;

FIGS. 2a and 2b are diagrams showing a conventional non-powered leakage blocking device;

FIG. 3 is a view schematically showing a state in which a non-powered water leakage blocking device according to an embodiment of the present invention is installed;

FIG. 4 is an enlarged sectional view showing the non-powered water leakage blocking device according to the embodiment of the present invention;

FIG. 5 is a perspective view showing a leakage blocking member according to an embodiment of the present invention;

FIG. 6 is a view showing a state in which leakage occurs and a leakage blocking member absorbs water and is decomposed;

FIG. 7 is a view showing a state in which an opening/closing member according to an embodiment of the present invention blocks a flow path;

FIG. 8a is an enlarged view of a non-powered leakage blocking device according to another embodiment of the present invention;

FIG. 8b is a diagram showing the operation of the non-powered leakage blocking device according to the other embodiment of the present invention;

FIG. 9 is a perspective view showing an opening/closing member according to another embodiment of the present invention; and

FIGS. 10a and 10b are diagrams showing the operation of the opening/closing member according to the other embodiment of the present invention.

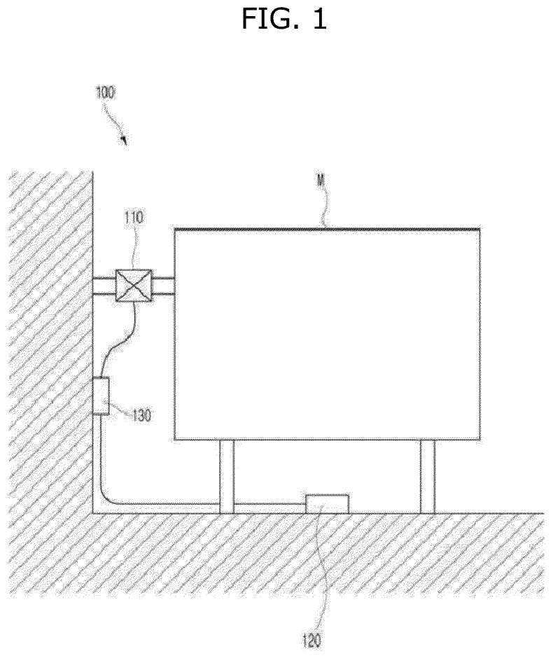

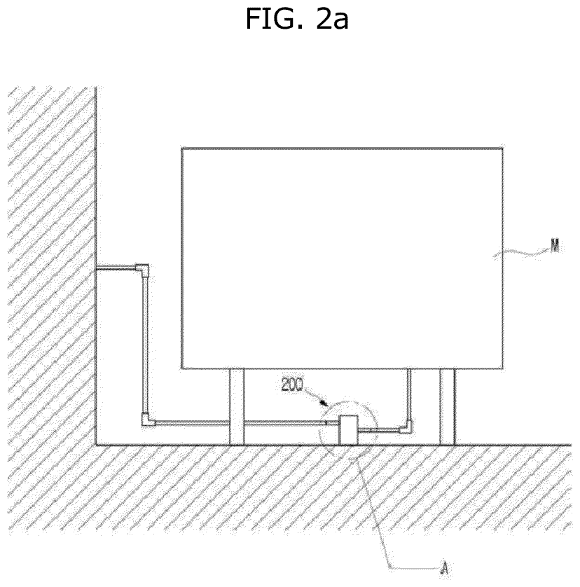

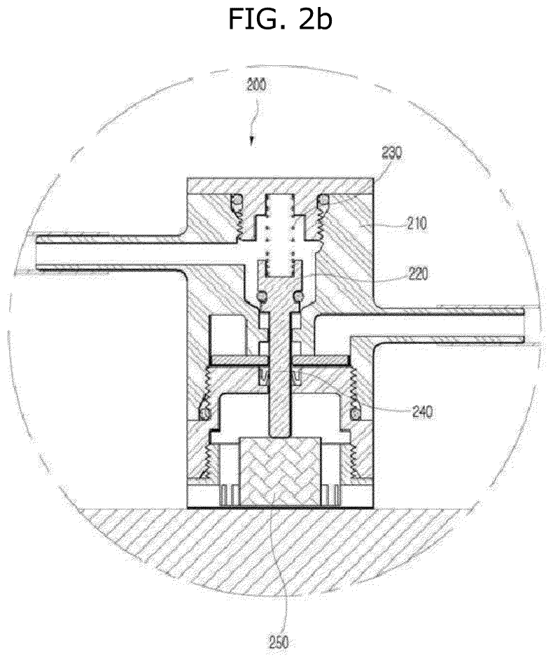

### DETAILED DESCRIPTION

Embodiments of the present invention will be described in detail below with reference to the accompanying drawings.

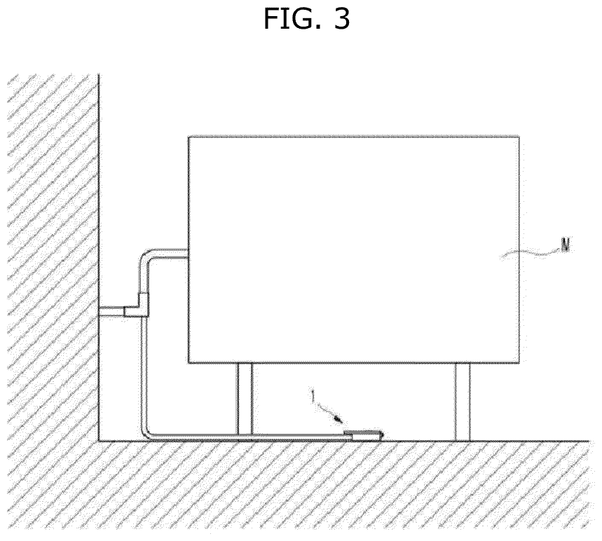

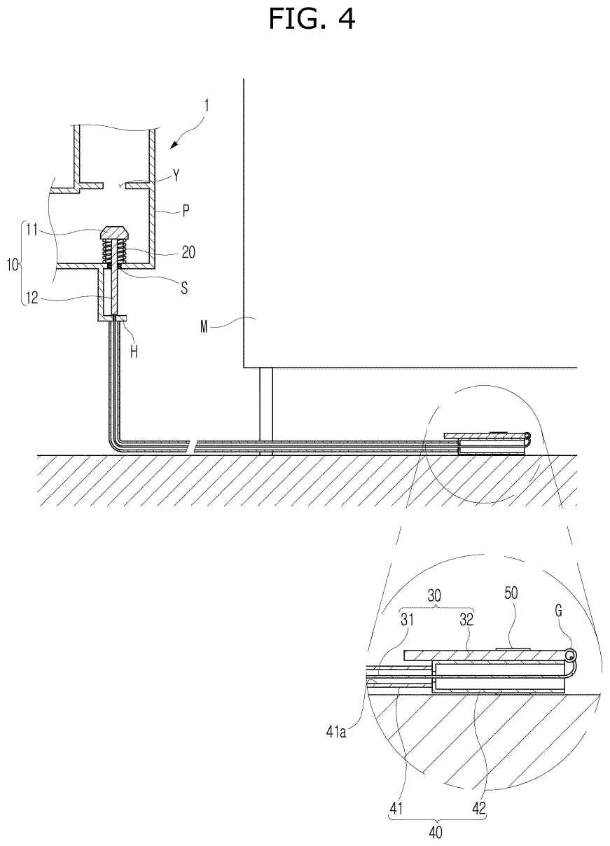

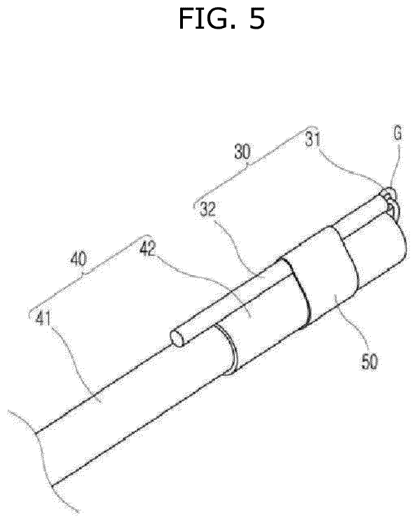

FIG. 3 is a view schematically showing a state in which a non-powered water leakage blocking device according to an embodiment of the present invention is installed, FIG. 4 is an enlarged sectional view showing the non-powered water leakage blocking device according to the embodiment of the present invention, and FIG. 5 is a perspective view showing a leakage blocking member according to an embodiment of the present invention.

As shown in FIGS. 3 to 5, the non-powered water leakage blocking device according to the present embodiment includes an opening/closing member 10, an elastic member 20, a wire member 30, and a support member 40, and a leakage blocking member 50.

The opening/closing member 10 is installed at a position corresponding to a flow path Y in a pipe P and serves to selectively open and close the flow path Y, and is preferably formed of a structure or material having high sealing performance.

In this case, the pipe P is connected, on one side thereof, to a water pipe or branched pipe through which water is supplied from the outside and connected, on the other side thereof, to a water supply target object M, and supplies water to the water supply target object M.

Meanwhile, the opening/closing member 10 according to the present invention may be installed in various shapes or directions according to the structure of the flow path Y in the pipe P. In the present embodiment, as shown in FIG. 4, there is used the opening/closing member 10 having a shape in which the truncated cone 11 and the cylindrical column 12 are integrated with each other. As the cylindrical column 12 reciprocates through the pipe P, the operation of selectively opening and closing the flow path Y is performed more stably. In this case, the pipe P having a protrusion H is used, and one side of a tube 41 to be described later is installed on the protrusion H. Although not shown, in another embodiment, a substantially truncated cone-shaped opening/closing member 10 is installed inside the pipe P, and an operation wire 31 to be described later passes through the pipe P and is connected to the opening/closing member 10. In this case, the protrusion H of the pipe P is unnecessary, so that the structure of the pipe P is simple and the shape of the opening/closing member 10 is also simple, but there is a possibility of erroneous operation. A sealing member S is installed on one side where the opening/closing member 10 or the operation wire 31 reciprocates through the pipe P.

The elastic member 20 may be a general coil spring, and is interposed between the pipe P and the opening/closing member 10 to provide elastic force to the opening/closing member 10 in the direction in which the flow path Y is blocked.

The wire member 30 may include the operation wire 31 having one end connected to one side of the opening/closing member 10 and an auxiliary fixation member 32 coupled to the other end of the operation wire 31. The operation wire 31 maintains the open state of the flow path Y by providing tension between the opening/closing member 10 and a fixation member 42 when the auxiliary fixation member 32 is fixed to the fixation member 42 to be described later in a state in which the opening/closing member 10 opens the flow path Y.

In addition, the auxiliary fixation member 32 is formed in a substantially bar shape, and serves to allow the other end of the wire member 30 to be more easily fixed to one side of the outer surface of the support member 40. Furthermore, it is preferred that the auxiliary fixation member 32 is provided with a ring G at the end thereof to which the operation wire 31 is connected and the operation wire 31 is connected to the ring G, so that erroneous operation is minimized by preventing the operation wire 31 from being easily bent.

The support member 40 includes the tube 41 configured such that one side thereof is disposed in the pipe P and the fixation member 42 installed to fix one side of the other end of the wire member 30.

A hollow 41a is formed in the tube 41, and the tube 41 allows the operation wire 31 to be inserted therein and to stably move along the arrangement path of the tube 41.

In this case, the tube 41 and the operation wire 31 are preferably made of a material that is flexibly bent.

The fixation member 42 serves to support the other end of the wire member 30, i.e., the auxiliary fixation member 32, at a predetermined position. Furthermore, although the fixation member 42 may be formed in a cylindrical, semi-cylindrical, or rod shape, the fixation member 42 is described as a cylindrical shape in the present embodiment.

The leakage blocking member 50 serves to fix the auxiliary fixation member 32 to one side of the fixation member 42, and absorbs the leaked water when leakage occurs and is decomposed to release the fixation.

Although any material that is rapidly decomposed upon absorbing water may be used for the leakage blocking member 50, a paper material is used in the present embodiment.

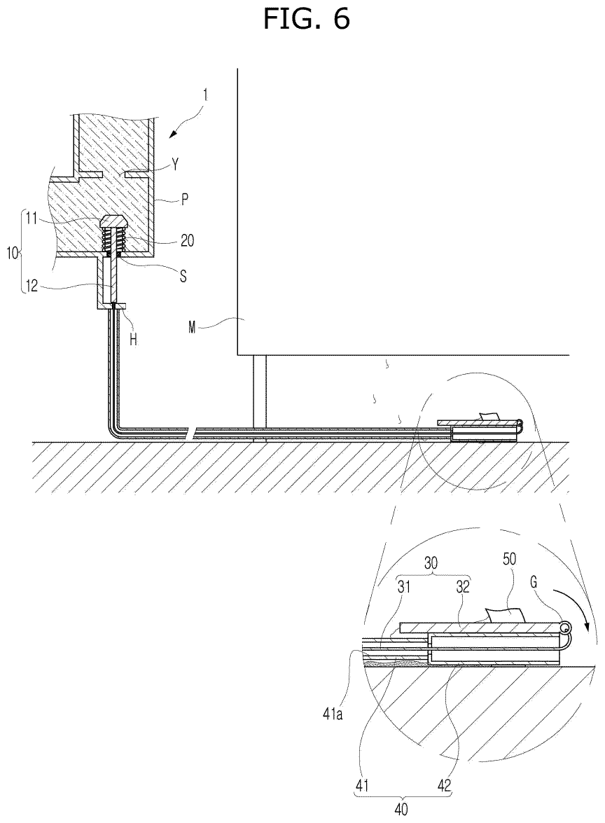

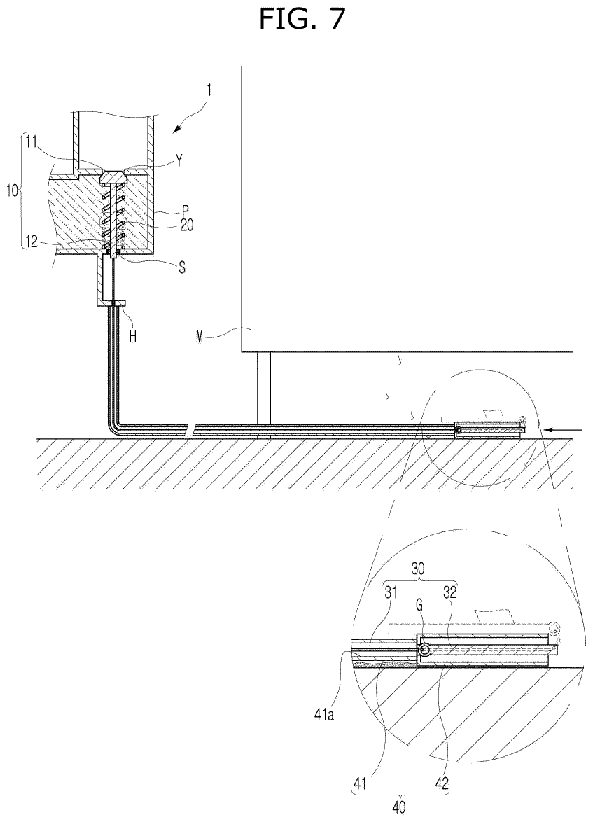

FIG. 6 is a view showing a state in which leakage occurs and a leakage blocking member absorbs water and is decomposed, and FIG. 7 is a view showing a state in which an opening/closing member according to an embodiment of the present invention blocks a flow path.

The operation of the non-powered water leakage blocking device according to the embodiment of the present invention, which is configured as described above, will be described below with reference to FIGS. 6 and 7.

First, in regard to a method of setting the leakage blocking member 50 according to an embodiment of the present invention, the opening/closing member 10 is caused to open the flow path Y by pulling the auxiliary fixation member 32.

Then, the auxiliary fixation member 32 is placed on the outer surface of the fixation member 42, and the fixation member 42 and the auxiliary fixation member 32 are wound and fixed with the water leakage blocking member 50 and are then placed on the floor where the water supply target object M is installed or at the position where leaked water flows.

Thereafter, when water leakage occurs and leaked water flows into the position where the water leakage blocking member 50 is disposed, the water leakage blocking member 50 absorbs the leaked water and is decomposed, so that the state in which the auxiliary fixation member 32 and the fixation member 42 are fixed is released.

When the fixed state is released and thus the auxiliary fixation member 32 is separated from the fixation member 42, water supply is stopped in such a manner that the opening/closing member 10 closes the flow path Y due to the restoring force of the elastic member 20.

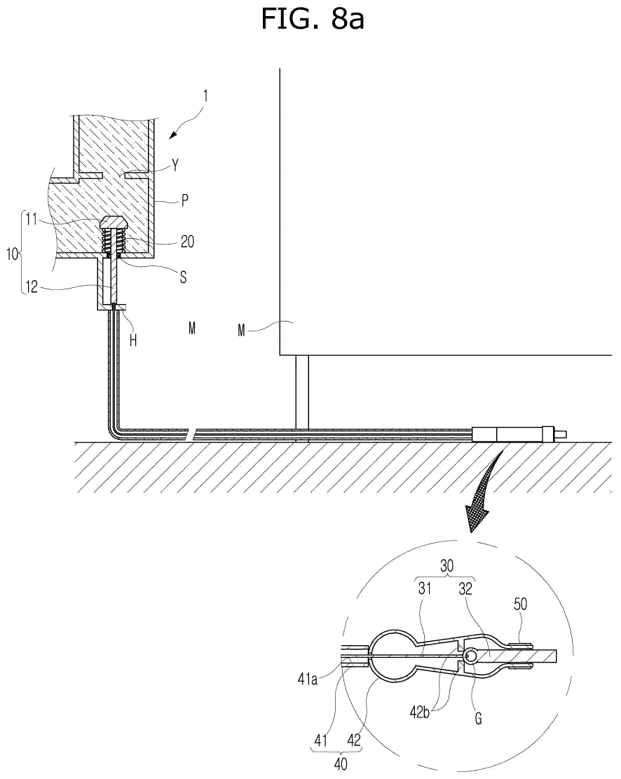

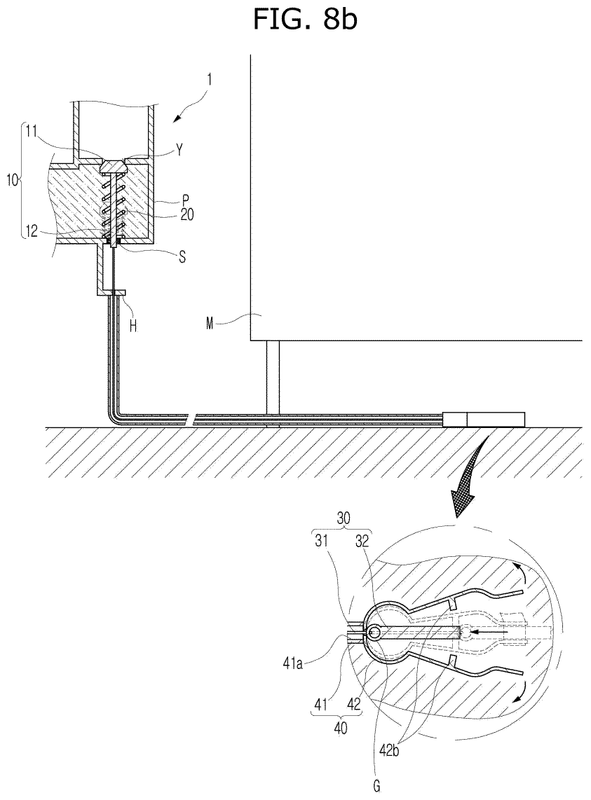

FIG. 8a is an enlarged view of a non-powered leakage blocking device according to another embodiment of the present invention, and FIG. 8b is a diagram showing the operation of the non-powered leakage blocking device according to the other embodiment of the present invention.

Although the basic configuration of the embodiment shown in FIGS. 8a and 8b is the same as that of the embodiment shown in FIGS. 3 to 7, the embodiment shown in FIGS. 8a and 8b is formed in a structure in which the state in which the auxiliary fixation member 32 and the fixation member 42 are fixed can be more stably maintained.

As shown in FIG. 8a, in the present embodiment, both sides of the fixation member 42 are formed such that one side thereof is coupled to the other side of the tube 41 and the other side thereof is spread and has elasticity, and support protrusions 42b are formed in regions facing each other on the inner surfaces of both sides, unlike in the previous embodiment.

One end of the operation wire 31 is connected to one side of the opening/closing member 10 and the auxiliary fixation member 32 coupled to the other end of the operation wire 31 is supported by the support protrusions 42b so that the state in which the flow path Y is opened by the opening/closing member is maintained.

The setting method and operation of the non-powered water leakage blocking device according to the other embodiment of the present invention, which is configured as described above, will be described below with reference to FIGS. 8a and 8b.

First, in regard to the method of setting the leakage blocking member 50 according to an embodiment of the present invention, an operator pulls the auxiliary fixation member 32 so that the opening/closing member 10 opens the flow path Y.

Furthermore, both sides of the fixation member 42 are brought close to each other so that the auxiliary fixation member 32 is supported by the pair of support protrusions 42b, and the auxiliary fixation member 32 supported by the support protrusions 42b is maintained in a fixed state by winding the leakage blocking member 50 around the outer surfaces of both sides of the fixation member 42.

Thereafter, when water leakage occurs and leaked water flows into the fixation member 42, the leakage blocking member 50 absorbs the leaked water and is decomposed, and thus both sides of the fixation member 42 are spread outward.

In this case, as the pair of support protrusions 42b are also spread in a direction in which they become spaced apart from each other, the state in which the auxiliary fixation member 32 is supported is released, and the opening/closing member 10 is caused to block the flow path Y by the elastic member 20.

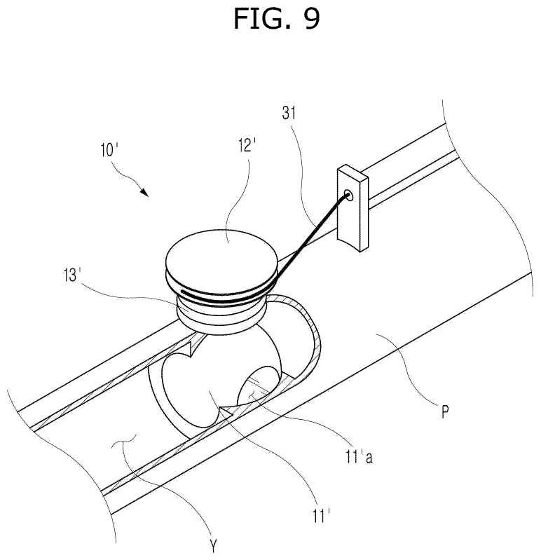

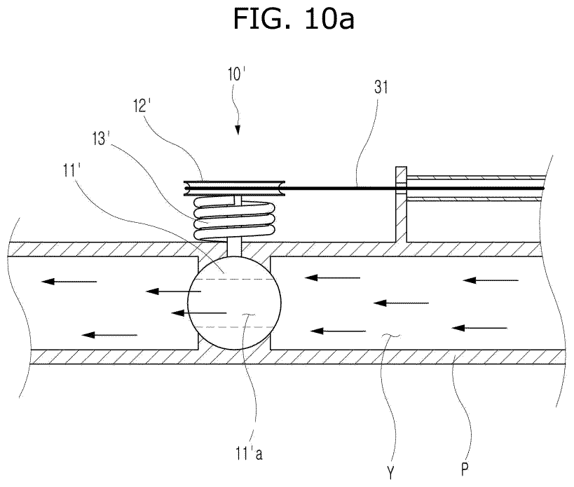

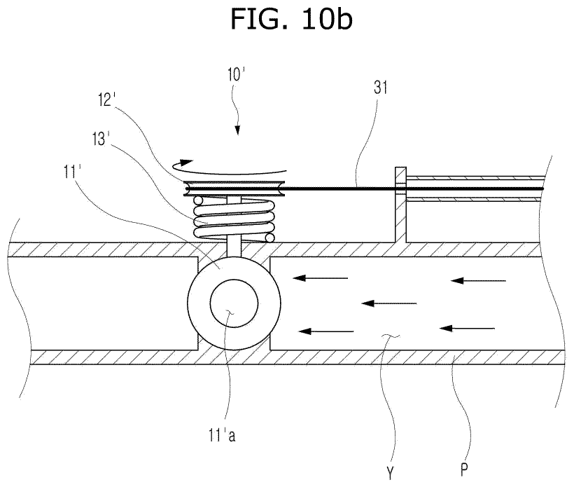

FIG. 9 is a perspective view showing an opening/closing member according to another embodiment of the present invention, and FIGS. 10a and 10b are diagrams showing the operation of the opening/closing member according to the other embodiment of the present invention.

Although the basic configuration of the embodiment shown in FIGS. 9 to 10b is the same as that of the embodiment shown in FIGS. 3 to 8b, the embodiment shown in FIGS. 9 to 10b is configured such that an opening/closing member 10′ is formed to be of a rotational type.

As shown in FIG. 9, in the present embodiment, the opening and closing member 10′ is formed in a substantially spherical shape, and is provided with a hole 11′a formed in the center thereof, unlike in the previous embodiment. The opening/closing member 10′ includes: a valve unit 11′ rotatably installed in a pipe P and configured to selectively open and close the flow path Y; a handle 12′ integrated with a valve unit 11′ and connected to an operation wire 31; and an elastic element 13′ interposed between the pipe P and the handle 12′.

In the present embodiment, as shown in FIG. 10a, before leakage occurs, the valve unit 11′ maintains the state in which the flow path Y is opened. When the state in which the auxiliary fixation member 32 is supported is released due to water leakage, the support state of the operating wire 31 supporting the handle 12′ is also released, as shown in FIG. 10b. Accordingly, the handle 12′ is rotated by the rotational restoring force of the elastic element 13′, and the valve unit 11′ integrated with the handle 12′ is rotated together, thereby closing the flow path Y.

Although not shown in the drawings, in another form, one end of the elastic element 13′ is connected to the edge of the handle and the other end thereof is connected to a pipe, so that the handle can be rotated by a telescopic operation due to the restoring force of the elastic element 13′.

Since other structures are the same as those of the above-described basic embodiment, descriptions thereof will be omitted.

According to the present invention described above, there are effects that an installation position can be selected freely, water leakage can be blocked rapidly, and the present invention can be applied to various valve structures.

Although the present invention has been described with respect to the above-mentioned preferred embodiments, it may be possible to make various modifications and variations without departing from the spirit and scope of the invention. Accordingly, the scope of the appended claims will include such modifications and variations that fall within the scope of this invention.

What is claimed is:

1. A non-powered water leakage blocking device, the non-powered water leakage blocking device being installed on one side of a pipe through which fluid moves and blocking a flow path of the pipe when leakage occurs, the non-powered water leakage blocking device comprising:
an opening/closing member configured to be installed on one side of the pipe and selectively open and close the flow path;
an elastic member configured to be interposed between the pipe and the opening/closing member and provide elastic force to the opening/closing member in a direction in which the flow path is blocked;
a wire member configured such that one end thereof is connected to one side of the opening/closing member and a remaining end thereof extends;
a support member formed to surround one side of an outer surface of the wire member; and
a leakage blocking member configured to fix the remaining end of the wire member to one side of the support member in a state in which the wire member is pulled such that the opening/closing member opens the flow path, and further configured to be decomposed by leaked fluid and thus release a state in which the wire member is fixed.

2. The non-powered water leakage blocking device of claim 1, wherein the support member comprises:
a tube installed to surround at least a portion of the outer surface of the wire member, and configured such that one side thereof is disposed in the pipe; and
a fixation member installed on a remaining side of the tube, and configured such that the remaining end of the wire member is fixed to one side thereof by the leakage blocking member.

3. The non-powered water leakage blocking device of claim 1, wherein the wire member comprises:
an operation wire configured such that one end thereof is connected to one side of the opening/closing member; and
an auxiliary fixation member coupled to a remaining end of the operation wire, and configured to be fixed to one side of the support member by the leakage blocking member and be released from a fixed state when the leakage blocking member is decomposed.

4. The non-powered water leakage blocking device of claim 2, wherein:
the fixation member is configured such that both side portions thereof are formed such that one side thereof is installed on the remaining side of the tube and a remaining side thereof is spread to have elasticity, and support protrusions are formed on insides of the both side portions; and
the remaining end of the wire member is fixed to the fixation member by winding the leakage blocking member around outer surfaces of the both side portions of the fixation member in a state in which both sides of the fixation member are brought close to each other and the remaining end of the wire member is supported by the support protrusions.

5. The non-powered water leakage blocking device of claim 1, wherein the opening/closing member comprises:
a valve unit rotatably installed in the pipe, and configured to selectively open and close the flow path;
a handle integrated with the valve unit, and connected to the wire member; and
an elastic element interposed between the pipe and the handle, and configured to provide rotational force to the handle.
